(19) United States
(12) Patent Application Publication
(10) Pub. No.: US 2018/0343109 A1
(43) Pub. Date: Nov. 29, 2018

(54) CRYPTOGRAPHIC SYSTEM, HOMOMORPHIC SIGNATURE METHOD, AND COMPUTER READABLE MEDIUM

(71) Applicant: Mitsubishi Electric Corporation, Tokyo (JP)

(72) Inventors: Yoshihiro KOSEKI, Tokyo (JP); Yutaka KAWAI, Tokyo (JP)

(73) Assignee: Mitsubishi Electric Corporation, Tokyo (JP)

(21) Appl. No.: 15/761,568

(22) PCT Filed: Oct. 8, 2015
(86) PCT No.: PCT/JP2015/078678

§ 371 Date: Mar. 20, 2018

(51) Int. Cl. H04L 9/00; H04L 9/08; H04L 9/32

(52) U.S. Cl. CPC H04L 9/008; H04L 9/3247; H04L 9/0861

(57) ABSTRACT

An object is to securely implement character position interchange in a character string while maintaining signature security. There are included a signature generation apparatus to generate a first signature a for a message m including N (N being an integer not less than two) characters, using a signature key sk, and a homomorphic operation apparatus to obtain a parameter j being an integer not less than one and not more than N−1 and to generate a second signature σ′ for an altered message where a jth character indicated by the parameter and a j+1th character in the message m are interchanged, using the parameter j, the first signature σ, and a homomorphic key hk different from the signature key sk.

### TECHNICAL FIELD

The present invention relates to a cryptographic system, a homomorphic signature method, and a homomorphic signature program.

### BACKGROUND ART

Electronic signatures are a technique whereby, by generation of a signature for a message by a signatory, using a secret key and by verification of a set of the signature and the message by a verifier, using a verification key, it is guaranteed that falsification of the message is not performed. In a usual electronic signature, when a signature is generated for a message and even a minute alteration is applied to the message, the message is not verified to be a proper message in order to detect any falsification of the message. Accordingly, no editing can be performed for the message for which the signature has been generated.

On the other hand, homomorphic signatures refer to a scheme where a message for which a signature has been generated can be altered within a certain range, or a signature for the message that has been altered can be generated from the signature of the original message. Various homomorphic signature schemes have been proposed, according to types of the alterations that can be made for the message. Patent Literature 1 and Non-Patent Literature 1, for example, describe about a scheme in which, when a message is regarded as a vector, the message can be altered to a linear sum of a plurality of vectors, using signatures of the vectors. Non-Patent Literature 2 describes a scheme in which, when a message is regarded as a set, the message can be altered to its subset, or when the message is regarded as a character string, the message can be altered to its partial character string.

### CITATION LIST

### Patent Literature

Patent Literature 1: JP 2014-158265 A

### Non-Patent Literature

Non-Patent Literature 1: B. LIBERT, M. JOYE, M. YUNG “Linearly homomorphic structure-preserving signatures and their applications” Advances in Cryptology-CRYPTO 2013, LNCS 8043, pp. 289-307, 2013

Non-Patent Literature 2: N. ATTRAPADUNG, B. LIBERT, T. PETERS “Computing on Authenticated Data: New Privacy Definitions and Constructions” Advances in Cryptology-ASIACRYPT 2012, LNCS 7658, pp. 367-385, 2012

### SUMMARY OF INVENTION

### Technical Problem

In the homomorphic signatures, an increase in the types of the alterations that can be made for the message is necessary in order to create various applications. For any of conventional homomorphic signatures, no scheme is present which implements character position interchange in a character string, as an alteration type. This is because, in mathematical structures and the alteration methods used in the conventional schemes, it has been difficult to implement the character position interchange in the character string while maintaining signature security. That is, there is a problem that in the conventional homomorphic signatures, the character position interchange in the character string cannot be implemented as the alteration type.

An object of the present invention is to implement a homomorphic signature scheme capable of securely implement character position interchange in a character string while maintaining signature security by using a mathematical structure different from mathematical structures used in conventional schemes.

### Solution to Problem

A cryptographic system according to the present invention may include:

a signature generation apparatus to generate a first signature for a message including N (N being an integer not less than two) characters, using a signature key; and

a homomorphic operation apparatus to generate a second signature for an altered message where two characters at different positions in the message are interchanged, using the first signature and a homomorphic key different from the signature key.

### Advantageous Effects of Invention

According to the cryptographic system of the present invention, the second signature for the altered message, in which the two characters at the different positions in the message are interchanged, can be generated, using the signature and the homomorphic key. Thus, an effect can be achieved that a homomorphic signature scheme which implements the character position interchange of the characters while maintaining signature security can be provided.

### BRIEF DESCRIPTION OF DRAWINGS

FIG. 1 is a system configuration diagram of a cryptographic system 100 according to a first embodiment.

FIG. 2 is a diagram illustrating a configuration of a key generation apparatus 101 according to the first embodiment.

FIG. 3 is a diagram illustrating a configuration of a signature generation apparatus 102 according to the first embodiment.

FIG. 4 is a diagram illustrating a configuration of a homomorphic operation apparatus 103 according to the first embodiment.

FIG. 5 is a diagram illustrating a configuration of a signature verification apparatus 104 according to the first embodiment.

FIG. 6 is a flow diagram illustrating each of a homomorphic signature process S100 and a homomorphic signature method 500 in the cryptographic system 100 according to the first embodiment.

FIG. 7 is a flow diagram illustrating a process flow of a key generation process S101 according to the first embodiment.

FIG. 8 is a flow diagram of a key generation algorithm execution process (step S112) that is the execution process of a key generation algorithm according to the first embodiment.

FIG. 9 is a flow diagram of the key generation algorithm execution process (step S112) that is the execution process of the key generation algorithm according to the first embodiment.

FIG. 10 is a flow diagram illustrating a process flow of a signature generation process S102 according to the first embodiment.

FIG. 11 is a flow diagram of a signature generation algorithm execution process (step S122) that is the execution process of a signature generation algorithm according to the first embodiment.

FIG. 12 is a flow diagram illustrating a process flow of a homomorphic operation process S103 according to the first embodiment.

FIG. 13 is a flow diagram of a homomorphic operation algorithm execution process (step S132) that is the execution process of a homomorphic operation algorithm according to the first embodiment.

FIG. 14 is a flow diagram illustrating a process flow of a signature verification process S104 according to the first embodiment.

FIG. 15 is a flow diagram of a signature verification algorithm execution process (step S142) that is the execution process of a signature verification algorithm according to the first embodiment.

FIG. 16 is a diagram illustrating a configuration of the key generation apparatus 101 according to a variation example of the first embodiment.

FIG. 17 is a diagram illustrating a configuration of the signature generation apparatus 102 according to the variation example of the first embodiment.

FIG. 18 is a diagram illustrating a configuration of the homomorphic operation apparatus 103 according to the variation example of the first embodiment.

FIG. 19 is a diagram illustrating a configuration of the signature verification apparatus 104 according to the variation example of the first embodiment.

### DESCRIPTION OF EMBODIMENTS

First, the notations in a description of an embodiment will be explained below.

(1) y←A indicates that when A is a random variable or distribution, y is uniformly and randomly selected from A according to the distribution of A, or that y is a uniform random number on A.

(2) y:=z indicates that y is a set defined by z, or that z is substituted into a variable y.

(3) F_{q} indicates a finite field with an order q.

(4) Formula 1 described below indicates a vector representation in the finite field F_{q}.

(x₁, . . . , xₙ)∈ F_{q}ⁿ [Formula 1]

(5) X^{T} indicates a transposed matrix of a matrix X.

(6) B:=(b₁, . . . , b_{N}) and B*:=(b₁*, . . . , b_{N}*) respectively indicate a basis B constituted from vectors b₁, . . . , b_{N} and a basis B* constituted from vectors b₁*, . . . , b_{N}*.

(7) Formula 2 described below indicates notations using original coefficient vectors on the bases B and B*.

$${( {x}_{1} , … , {x}_{N} )}_{B} := {\sum }_{i = 1}^{N} {x}_{i} {{b}_{i} \\ ( {y}_{1} , … , {y}_{N} )}_{{B}^{*}} := {\sum }_{i = 1}^{N} {y}_{i} {b}_{i}^{*} \qquad [ Formula 2 ]$$

(8) Formula 3 described below indicates an N-dimensional vector space V over the finite field F_{q}.

$$V := \overbrace{G \times … \times G}^{N} \qquad [ Formula 3 ]$$

(9) Formula 4 described below indicates aᵢ of a canonical base A:=(a₁, . . . , a_{N}) of the space V.

$${a}_{i} := \overbrace{( 0 , … , 0}^{i - 1} , g , \overbrace{0 , … , 0 )}^{N - i} \qquad [ Formula 4 ]$$

(10) Formula 5 described below indicates a definition of pairing on the space V.

$$e ( x , y ) := {\prod }_{i = 1}^{N} e ( {G}_{i} , {H}_{i} ) ∈ {G}_{T} \\ ( \begin{matrix}x := ( {G}_{1} , … , {G}_{N} ) ∈ V \\ y := ( {H}_{1} , … , {H}_{N} ) ∈ V\end{matrix} ) \qquad [ Formula 5 ]$$

Subsequently, a mathematical concept in the description of the embodiment will be described below.

First, symmetric bilinear pairing groups will be described.

The symmetric bilinear pairing groups (q, G, G_{T}, g, e) are a tuple of a prime q, a cyclic additive group G of an order q to which the prime q is set, a cyclic multiplicative group G_{T} of the order q, g≠0 ∈ G, and a polynomial-time computable nondegenerate bilinear pairing e: G×G→G_{T}. The nondegenerate bilinear pairing signifies e(sg, tg)=e(g, g)^{st} where e(g, g)≠1.

Dual pairing vector spaces will now be described.

The dual pairing vector spaces (q, V, G_{T}, A, e) can be configured by a direct product of the symmetric bilinear pairing groups (q, G, G_{T}, g, e). The dual pairing vector spaces (q, V, G_{T}, A, e) are a tuple of the prime q, the N-dimensional vector space V over the F_{q} indicated in Formula 3, the cyclic multiplicative group G_{T} of the order q, the canonical basis A:=(a₁, . . . , a_{N}) of the space V, and the pairing e. aᵢ is as indicated by Formula 4.

The pairing on the space V is defined by Formula 5. This pairing is a nondegenerate bilinear type. That is, e(sx, ty)=e(x, y)^{st}. If e (x, y)=1 for all y ∈ V, x=0. Further, for all i and j, e(aᵢ, aⱼ)=e(g, g)^{δi,j}. if i=j, δ_{i,j} is obtained. If i≠j, δ_{i,j}=0. Further, e(g, g)≠1 ∈ G_{T}.

In this embodiment, a description will be directed to a case where dual pairing vector spaces are constructed from the symmetric bilinear pairing groups mentioned above. Dual pairing vector spaces can be constructed from asymmetric bilinear pairing groups as well. The following description can be applied to a case where the dual pairing vector spaces are constructed from the asymmetric bilinear pairing groups.

### First Embodiment

Description of Configuration

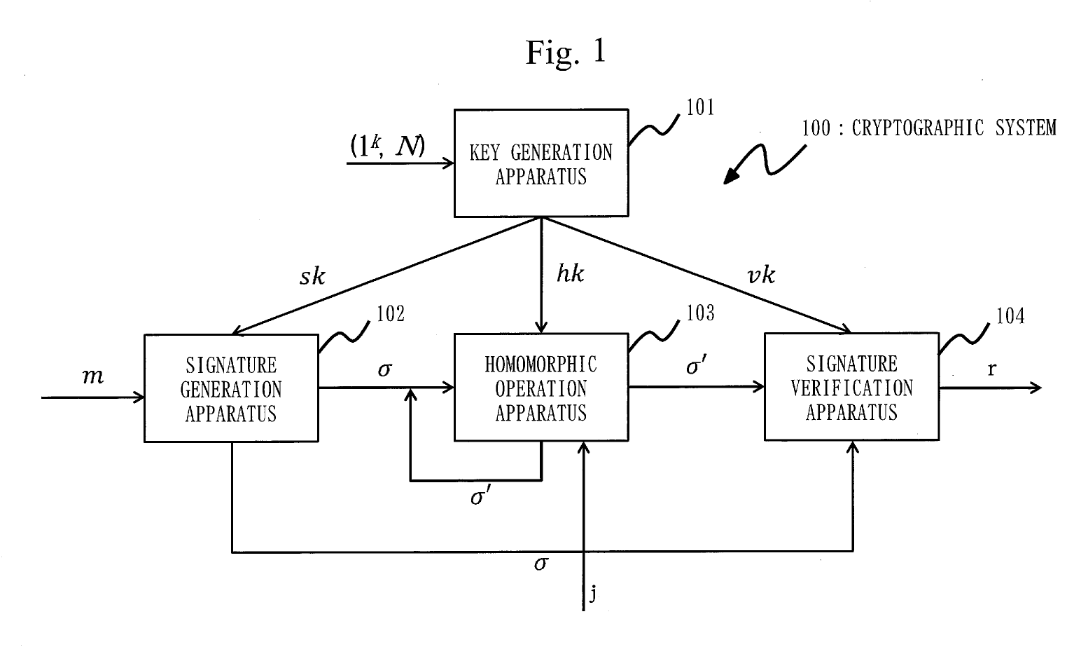

FIG. 1 is a system configuration diagram of a cryptographic system 100 according to this embodiment.

As illustrated in FIG. 1, the cryptographic system 100 includes a key generation apparatus 101, a signature generation apparatus 102, a homomorphic operation apparatus 103, and a signature verification apparatus 104.

First, functions of the respective apparatuses in the cryptographic system 100 will be outlined, using FIG. 1.

The key generation apparatus 101 obtains a key generation parameter (1^{k}, N) and executes a key generation algorithm, thereby generating a verification key vk, a signature key sk, and a homomorphic key hk.

Herein, in order to maintain security of the scheme in the cryptographic system 100, the signature key sk is given to only a user or an apparatus permitted to execute signature generation. The homomorphic key hk is given to only a user or an apparatus permitted to execute a homomorphic operation. The signature key sk and the homomorphic key hk are each a secret key that is concealed to a user or an apparatus that is not permitted, other than the above-mentioned users or apparatuses. The verification key vk is a public key.

The signature generation apparatus 102 obtains the signature key sk from the key generation apparatus 101, and obtains a message m through an input device. The signature generation apparatus 102 executes a signature generation algorithm based on the signature key sk and the message m that have been obtained, and outputs a first signature σ.

The homomorphic operation apparatus 103 obtains the homomorphic key hk from the key generation apparatus 101, obtains the first signature σ from the signature generation apparatus 102, and obtains a parameter j through an input device. The homomorphic operation apparatus 103 executes a homomorphic operation algorithm based on the homomorphic key hk, the first signature σ, and the parameter j that have been obtained, and outputs a second signature σ′. The second signature σ′ is a signature after the execution of the homomorphic operation algorithm, and is also referred to as an after-operation signature.

The signature verification apparatus 104 obtains the verification key vk from the key generation apparatus 101 and obtains a verification signature vσ, executes a signature verification algorithm, and outputs a verification result r of the verification signature vσ. Herein, the verification signature vσ is the first signature σ or the second signature σ′.

<Configuration of Key Generation Apparatus 101>

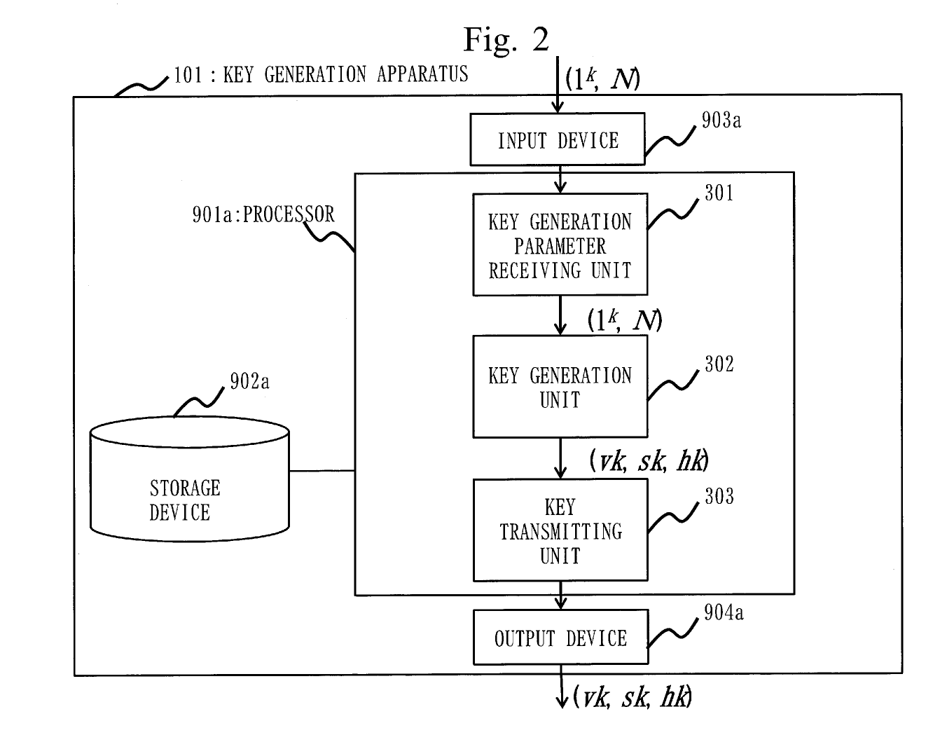

FIG. 2 is a diagram illustrating a configuration of the key generation apparatus 101 according to this embodiment.

The key generation apparatus 101 includes a key generation parameter receiving unit 301, a key generation unit 302, and a key transmitting unit 303.

The key generation apparatus 101 is a computer. Functions of the key generation parameter receiving unit 301, the key generation unit 302, and the key transmitting unit 303 in the key generation apparatus 101 are also referred to as functions of “units” of the key generation apparatus 101. A function of each “unit” of the key generation apparatus 101 is implemented by software. The key generation apparatus 101 includes hardware such as a processor 901a, a storage device 902a, an input device 903a, and an output device 904a.

<Configuration of Signature Generation Apparatus 102>

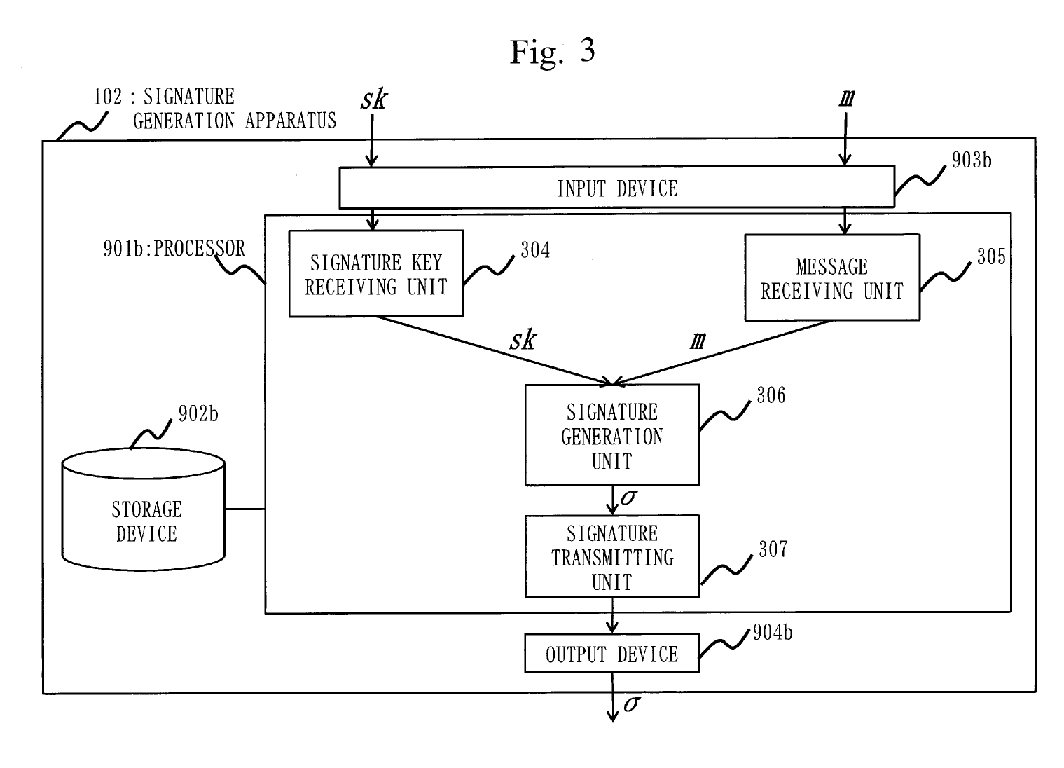

FIG. 3 is a diagram illustrating a configuration of the signature generation apparatus 102 according to this embodiment.

The signature generation apparatus 102 includes a signature key receiving unit 304, a message receiving unit 305, a signature generation unit 306, and a signature transmitting unit 307.

The signature generation apparatus 102 is a computer. Functions of the signature key receiving unit 304, the message receiving unit 305, the signature generation unit 306, and the signature transmitting unit 307 in the signature generation apparatus 102 are also referred to as functions of “units” of the signature generation apparatus 102. A function of each “unit” of the signature generation apparatus 102 is implemented by software. The signature generation apparatus 102 includes hardware such as a processor 901b, a storage device 902b, an input device 903b, and an output device 904b.

<Configuration of Homomorphic Operation Apparatus 103>

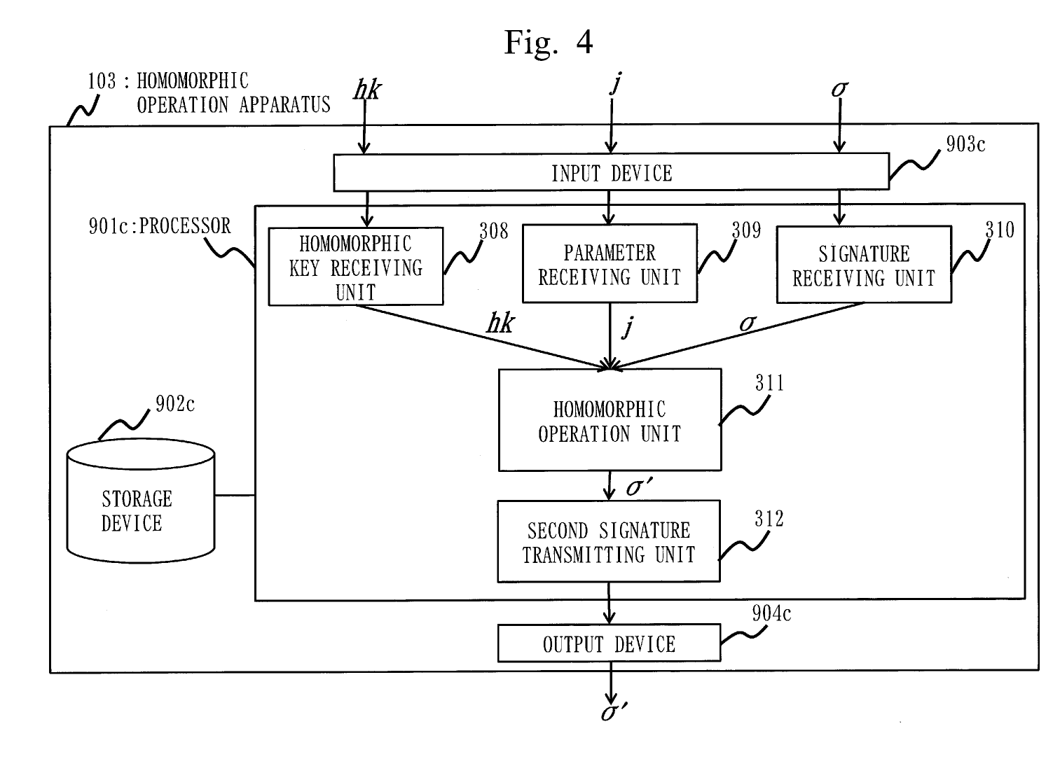

FIG. 4 is a diagram illustrating a configuration of the homomorphic operation apparatus 103 according to this embodiment.

The homomorphic operation apparatus 103 includes a homomorphic key receiving unit 308, a parameter receiving unit 309, a signature receiving unit 310, a homomorphic operation unit 311, and a second signature transmitting unit 312.

The homomorphic operation apparatus 103 is a computer. Functions of the homomorphic key receiving unit 308, the parameter receiving unit 309, the signature receiving unit 310, the homomorphic operation unit 311, and the second signature transmitting unit 312 in the homomorphic operation apparatus 103 are also referred to as functions of “units” of the homomorphic operation apparatus 103. A function of each “unit” of the homomorphic operation apparatus 103 is implemented by software. The homomorphic operation apparatus 103 includes hardware such as a processor 901c, a storage device 902c, an input device 903c, and an output device 904c.

<Configuration of Signature Verification Apparatus 104>

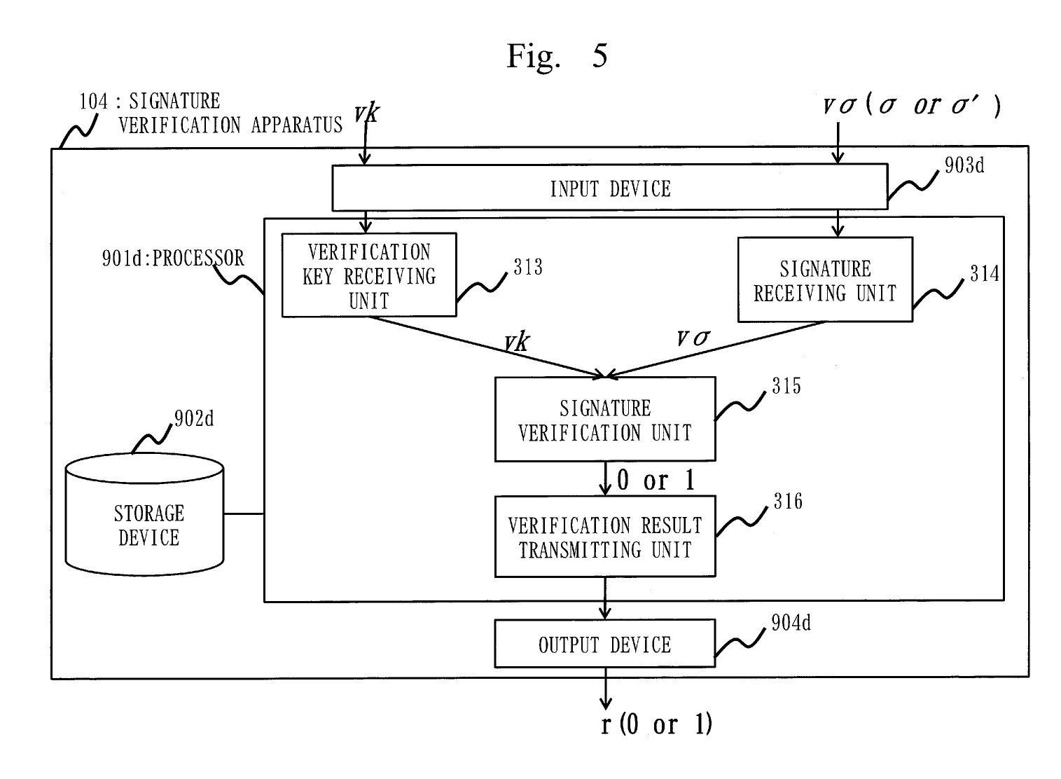

FIG. 5 is a diagram illustrating a configuration of the signature verification apparatus 104 according to this embodiment.

The signature verification apparatus 104 includes a verification key receiving unit 313, a signature receiving unit 314, a signature verification unit 315, and a verification result transmitting unit 316.

The signature verification apparatus 104 is a computer. Functions of the verification key receiving unit 313, the signature receiving unit 314, the signature verification unit 315, and the verification result transmitting unit 316 in the signature verification apparatus 104 are also referred to as functions of “units” of the signature verification apparatus 104. A function of each “unit” of the signature verification apparatus 104 is implemented by software. The signature verification apparatus 104 includes hardware such as a processor 901d, a storage device 902d, an input device 903d, and an output device 904d.

Now, the hardware of each apparatus included in the cryptographic system 100 will be described, using FIGS. 2 to 5. In the following description, the processors 901a, 901b, 901c, and 901d will be collectively referred to as a processor 901. The same holds true for a storage device 902, an input device 903, and an output device 904. Each apparatus of the key generation apparatus 101, the signature generation apparatus 102, the homomorphic operation apparatus 103, and the signature verification apparatus 104 is also referred to as each apparatus of the cryptographic system 100.

Each apparatus of the cryptographic system 100 includes the hardware such as the processor 901, the storage device 902, the input device 903, and the output device 904. The processor 901 is connected to the other hardware via a signal line, and controls these other hardware.

The processor 901 is an IC (Integrated Circuit) to perform processing. Specifically, the processor 901 is a CPU (Central Processing Unit).

The storage device 902 includes an auxiliary storage device and a memory. Specifically, the auxiliary storage device is a ROM (Read Only Memory), a flash memory, or an HDD (Hard Disk Drive). Specifically, the memory is a RAM (Random Access Memory).

As a specific example of the input device 903, there is a mouse, a keyboard, or a touch panel.

As a specific example of the output device 904, there is a display. Specifically, the display is an LCD (Liquid Crystal Display).

Each apparatus of the cryptographic system 100 may include a communication device. The communication device includes a receiver to receive data and a transmitter to transmit data. Specifically, the communication device is a communication chip or an NIC (Network Interface Card). The communication device may be used as each of the input device 903 and the output device 904.

A program to implement the function of each “unit” is stored in the auxiliary storage device. This program is loaded into the memory, is read into the processor 901, and is executed by the processor 901. An OS (Operating System) is also stored in the auxiliary storage device. At least a part of the OS is loaded into the memory, and the processor 901 executes the program to implement the function of each “unit” while executing the OS.

Each apparatus of the cryptographic system 100 may include only one processor 901, or a plurality of the processors 901. The plurality of the processors 901 may cooperate and execute the program to implement the function of each “unit”.

Information, data, signal values, and variable values indicating results of processes of the “units” are stored in the auxiliary storage device, the memory, or a register or a cache memory in the processor 901.

The program to implement the function of each “unit” may be stored in a portable storage medium such as a magnetic disk, a flexible disk, an optical disk, a compact disk, a blue ray (registered trade mark) disk, or a DVD (Digital Versatile Disc).

A homomorphic signature program 510 is a program to implement the function described as each “unit” of each apparatus in the cryptographic system 100. Further, what is referred to as a homomorphic program product is a storage medium or a storage device in which the program to implement the function described as each “unit” is stored, and is a product of any appearance in which a computer readable program is loaded.

‡‡‡Description of Operations‡‡‡

<Homomorphic Signature Process S100 and Homomorphic Signature Method 500 of Cryptographic System 100>

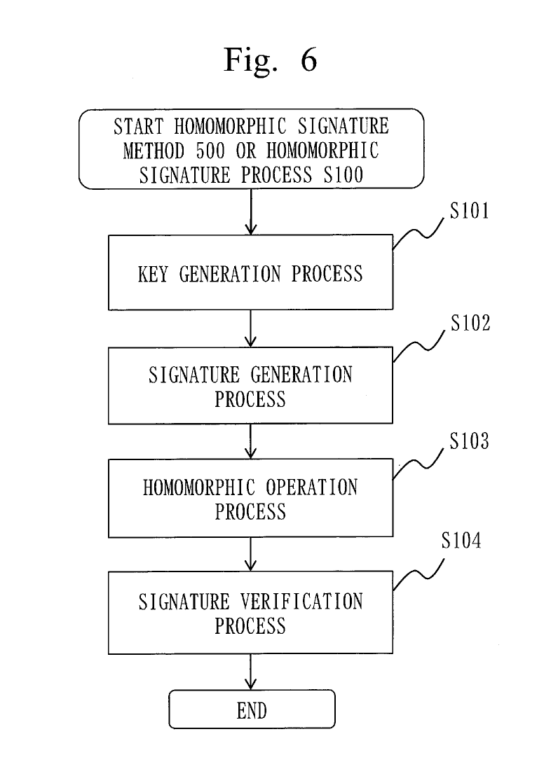

FIG. 6 is a flow diagram illustrating a flow of each of the homomorphic signature process S100 and the homomorphic signature method 500 of the cryptographic system 100 according to this embodiment.

In a key generation process S101, the key generation apparatus 101 obtains the key generation parameter (1^{k}, N), using the input device 903a, and generates the verification key vk, the signature key sk, and the homomorphic key hk.

In a signature generation process S102, the signature generation apparatus 102 obtains the signature key sk and the message m including N characters, using the input device 903b, and generates the first signature σ for the message m.

In a homomorphic operation process S103, the homomorphic operation apparatus 103 obtains the parameter j, the first signature σ, and the homomorphic key hk different from the signature key sk, using the input device 903c. Using the parameter j, the first signature σ, and the homomorphic key hk, the homomorphic operation apparatus 103 generates the second signature σ′ for an altered message where a jth character and a j+1th character of the message m are interchanged.

In a signature verification process S104, the signature verification apparatus 104 obtains the verification key vk and the verification signature vσ being the first signature σ or the second signature σ′, using the input device 903d, verifies the verification signature vσ, and outputs the verification result r.

<Operations of Key Generation Apparatus 101>

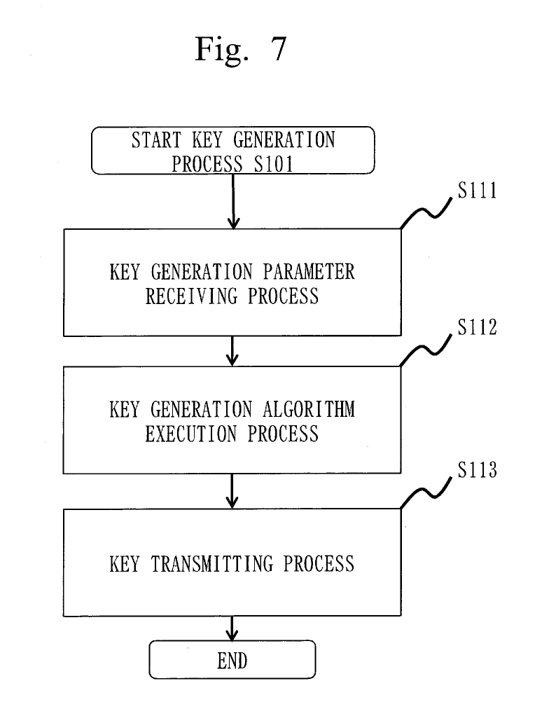

FIG. 7 is a flow diagram illustrating a process flow of the key generation process S101 according to this embodiment.

In step S111, the key generation parameter receiving unit 301 receives the key generation parameter (1^{k}, N), using the input device 903a such as the keyboard or the communication device. k is a security parameter indicating strength of each key to be generated. The key generation parameter receiving unit 301 writes, into the storage device 902a, the key generation parameter (1^{k}, N) received. Step S111 is a key generation parameter receiving process.

In step S112, the key generation unit 302 executes the key generation algorithm, based on the key generation parameter (1^{k}, N) written into the storage device 902a. The key generation unit 302 executes the key generation algorithm, thereby generating the verification key vk, the signature key sk, and the homomorphic key hk. The key generation unit 302 writes, into the storage device 902a, the verification key vk, the signature key sk, and the homomorphic key hk that have been generated. Step S112 is a key generation algorithm execution process.

In step S113, the key transmitting unit 303 publicizes the verification key vk, transmits the signature key sk to the signature generation apparatus 102, and transmits the homomorphic key hk to the homomorphic operation apparatus 103, using the output device 904a such as the communication device. The key generation apparatus 101 transmits the signature key sk to the signature generation apparatus 102, using a secure communication path, and transmits the homomorphic key hk to the homomorphic operation apparatus 103, using a secure communication path. Step S113 is also referred to as a key transmitting process.

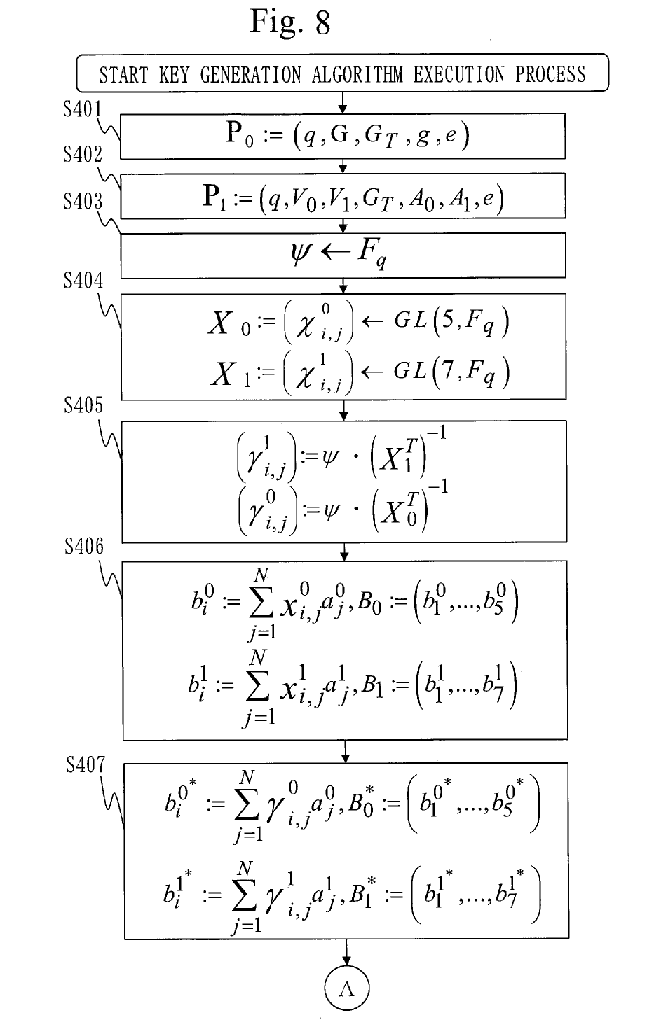

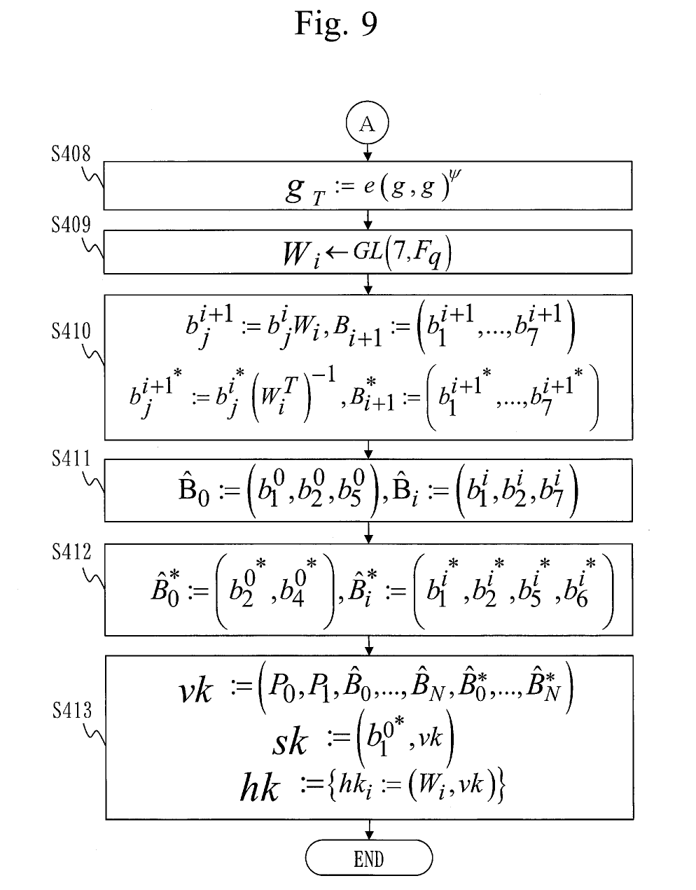

Each of FIGS. 8 and 9 is a flow diagram of the key generation algorithm execution process (step S112) that is the execution process of the key generation algorithm according to this embodiment.

Herein, the key generation parameter (1^{k}, N) the key generation parameter receiving unit 301 has received is constituted from the security parameter k indicating the strength of each key to be generated and a natural number N indicating the character string length of the message for which the signature is to be generated.

In step S401, the key generation unit 302 determines an order q, a cyclic additive group G of the order q, a cyclic multiplicative group G_{T} of the order q, a generator g of the cyclic additive group G, and a pairing e, as a parameter P₀ of symmetric bilinear pairing groups. The order q, the group G, the group G_{T}, and the generator g are herein generated by an existent algorithm to generate an elliptic curve such as a BN curve suitable for pairing. The pairing e is determined by selection of an existent pairing computation algorithm such as optimal ate pairing.

In step S402, the key generation unit 302 determines a parameter P₁ of dual pairing vector spaces, based on the parameter P₀ of the symmetric bilinear pairing groups. The parameter P₁ is a tuple of the order q, a five-dimensional vector space V₀, a seven-dimensional vector space V₁, the cyclic multiplicative group G_{T} of the order q, a canonical basis A₀ of the V₀, a canonical basis A₁ of the V₁, and the pairing e. The key generation unit 302 determines the parameter P₁ as a pairing on a direct product of the symmetric bilinear pairing groups.

In step S403, the key generation unit 302 generates a random number ψ.

In step S404, the key generation unit 302 generates X₀ and X₁ that are random matrices on F_{q} whose determinant is not 0. The X₀ has a size of 5×5, and the X₁ has a size of ×7.

In step S405, the key generation unit 302 generates (γ⁰_{i,j}):=ψ·(X₀^{T})⁻¹ and (γ¹_{i,j}):=ψ·(X₁^{T})⁻¹.

In step S406, the key generation unit 302 generates a basis B₀ from the canonical basis A₀ and generates a basis B₁ from the canonical A₁.

In step S407, the key generation unit 302 generates a basis B₀* from the canonical basis A₀ based on the (γ⁰_{i,j}), and generates a basis B₁* from the canonical basis A₁ based on the (γ¹_{i,j}).

In step S404 to step S407, i is each of integers from 1 to 5 in the equations for obtaining the X₀, the basis B₀, and the basis B₀*, and is each of integers from 1 to 7 in the equations for obtaining the X₁, the basis B₁, and the basis B₁*.

In step S408, the key generation unit 302 generates g_{T}:=e (g, g)ψ.

In step S409, the key generation unit 302 generates a random matrix on the F_{q} whose determinant is not 0 as N−1 transformation matrices W₁, . . . , W_{N-1}. Each size of the transformation matrices W₁, . . . , W_{N-1} is 7×7. In step S409, i in the Wᵢ is each of integers from 1 to N−1.

In step S410, the key generation unit 302 generates bases B₂, B₃, . . . , B_{N} and bases B₂*, B₃*, . . . , B_{N}^{N}*, based on the basis B₁, the basis B₁*, and the transformation matrices W₁, . . . , W_{N31 1}.

As mentioned above, the key generation unit 302 generates the bases B₀, . . . , B_{N} and bases B₀*, . . . , B_{N}* of the dual pairing vector spaces. In the bases B₀, . . . , B_{N}, the bases after the B₂ are generated by using the (N−1) transformation matrices W₁, . . . , W_{N31 1}. Further, in the bases B₀*, . . . , B_{N}*, the bases after the B₂* are generated by using the (N−1) transformation matrices W₁, . . . , W_{N-}1.

In step S410, i is each of the integers from 1 to N−1, and j is each of the integers from 1 to 7.

In step S411, the key generation unit 302 sets subbases B₀̂, . . . , B_{N}̂ from the bases B₀, . . . , B_{N}.

In step S412, the key generation unit 302 sets subbases B₀̂*, . . . , B_{N̂}* from the subbases B₀*, . . . , B_{N}*.

In step S411 and step S412, i is each of integers from 1 to N.

In step S413, the key generation unit 302 generates the verification key vk including a subset of the bases B₀, . . . , B_{N} of the dual pairing vector spaces. Specifically, the key generation unit 302 generates the verification key vk including the parameter P₀ of the symmetric bilinear pairing groups, the parameter P₁ of the dual pairing vector spaces, a subset B̂ of the respective bases B₀, . . . , B_{N} and a subset B̂* of the respective bases B₀*, . . . , B_{N}*.

The key generation unit 302 further generates the signature key sk including the subset of the respective bases B₀*, . . . , B_{N}*. Specifically, the key generation unit 302 generates the signature key sk including b₁^{0*} and the verification key vk.

Further, the key generation unit 302 sets the homomorphic key hk={hk₁, . . . , hk_{N -1}} including the transformation matrices W₁, . . . , W_{N-1} and the subset of the respective bases B₀*, . . . , B_{N}*. Specifically, the key generation unit 302 generates the homomorphic key hk={hk₁, . . . , hk_{N-1}} including the transformation matrices W₁, . . . , W_{N-1} and the verification key vk.

As mentioned above, the key generation unit 302 receives the key generation parameter constituted from the set of the security parameter k and the natural number N indicating the character string length of the message for which the signature is to be generated. The key generation unit 302 generates the parameter of the symmetric bilinear pairing groups, generates the parameter of the dual pairing vector spaces, generates the set of the random matrices, and generates the set of the bases of the dual pairing vector spaces from the set of the random matrices. Then, the key generation unit 302 makes the verification key vk constituted from the set of the random matrices, the subsets of the bases of the dual pairing vector spaces, the parameter of the symmetric bilinear pairing groups, and the parameter of the dual pairing vector spaces, the signature key sk constituted from the element of the bases of the dual pairing vector spaces and the verification key vk, and the homomorphic key hk constituted from the set of the random matrices and the verification key vk.

<Operations of Signature Generation Apparatus 102>

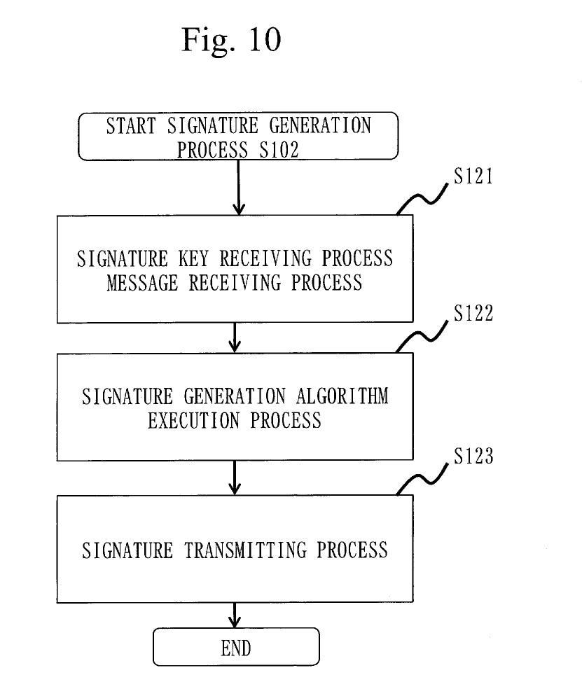

FIG. 10 is a flow diagram illustrating a process flow of the signature generation process S102 according to this embodiment.

In step S121, the signature key receiving unit 304 receives the signature key sk, using the input device 903b such as the communication device. The message receiving unit 305 receives the message m, using the input device 903b such as the keyboard or the communication device. The signature key sk and the message m are written into the storage device 902b. Step S121 is a signature key receiving process and a message receiving process.

In step S122, the signature generation unit 306 executes the signature generation algorithm based on the signature key sk and the message m written into the storage device 902b, thereby generating the first signature σ. The signature generation unit 306 writes, into the storage device 902b, the first signature σ generated. Step S122 is a signature generation algorithm execution process.

In step S123, the signature transmitting unit 307 transmits the first signature σ written into the storage device 902b to the homomorphic operation apparatus 103 or the signature verification apparatus 104, using the output device 904b such as the communication device. When the signature transmitting unit 307 transmits the first signature σ to the signature verification apparatus 104, the signature transmitting unit 307 transmits the first signature σ to the signature verification apparatus 104 as the verification signature vσ to be verified. Step S123 is a signature transmitting process.

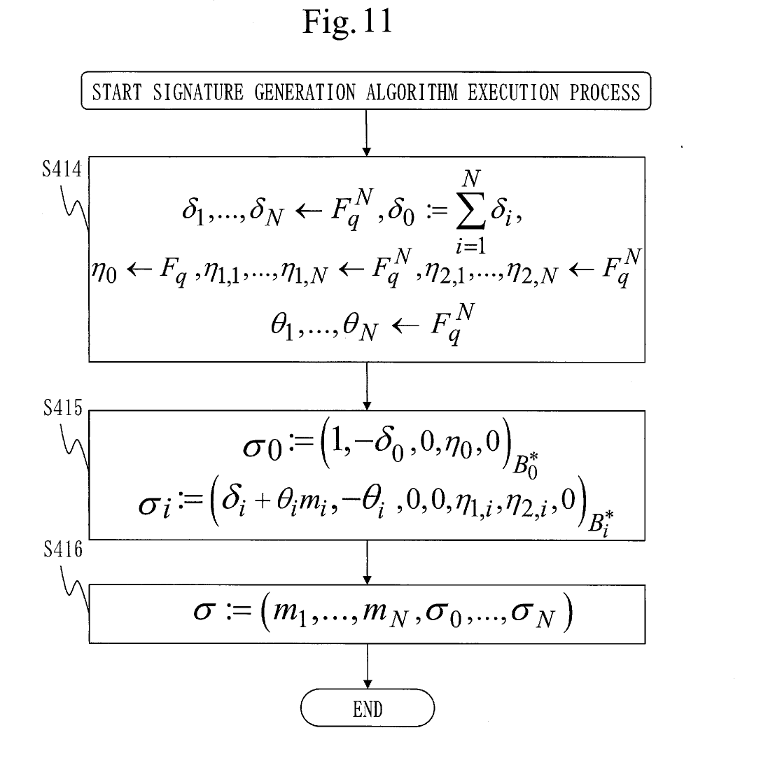

FIG. 11 is a flow diagram of the signature generation algorithm execution process (step S122) that is the execution process of the signature generation algorithm according to this embodiment.

Herein, the signature generation unit 306 inputs, to the signature generation algorithm execution process, the signature key sk the signature key receiving unit 304 has received and the message m the message receiving unit 305 has received. The message m is constituted from a vector with a length of N on the F_{q}.

In step S414, the signature generation unit 306 generates random numbers δ₀, . . . , δ_{N}, a random number η₀, random numbers η_{1, 1}, . . . , η_{1, N}, random numbers η_{2, 1}, . . . , η_{2, N}, and random numbers θ₁, . . . , θ_{N}.

In step S415, the signature generation unit 306 generates elements σ₀, . . . , σ_{N} on the dual pairing vector spaces, using the random numbers generated in step S414 and the bases B₀*, . . . , B_{N}*. The signature generation unit 306 generates a set of the elements σ₀, σ₁, . . . , σ_{N} that are the elements on the dual pairing vector spaces and include each character mᵢ contained in the message m (m₁, . . . , m_{N}), using the subset of the the respective bases B₀*, . . . , B_{N}* included in the signature key sk and the message m.

In step S416, the signature generation unit 306 generates the first signature including the set of the elements σ₀, . . . , σ₁, σ_{N} generated. Herein, the signature generation unit 306 generates and outputs the first signature σ including the message constituted from the m₁, . . . , m_{N} and the set of the elements σ₀, σ₁, . . . , σ_{N} generated.

<Operations of Homomorphic Operation Apparatus 103>

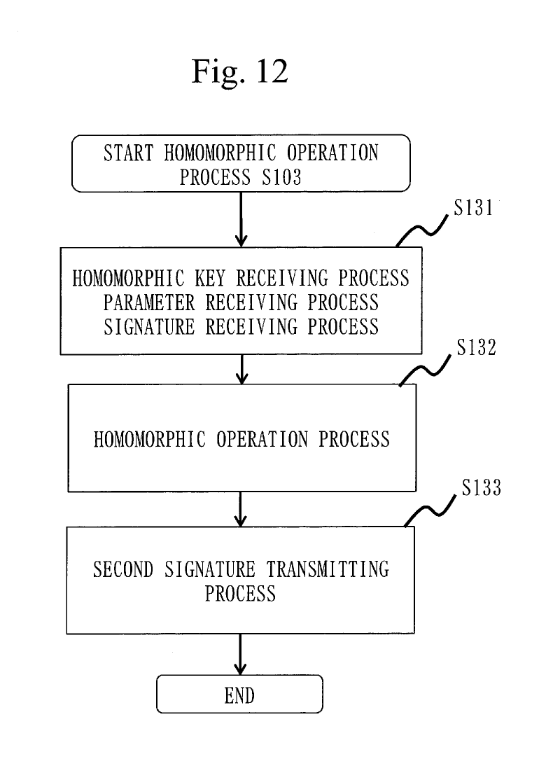

FIG. 12 is a flow diagram illustrating a process flow of the homomorphic operation process S103 according to this embodiment.

In the homomorphic operation process S103 by the homomorphic operation apparatus 103, the second signature σ′ for the altered message where two characters at different positions in the message m are interchanged is generated, using the first signature σ and the homomorphic key hk different from the signature key sk.

In step S131, the homomorphic key receiving unit 308 receives the homomorphic key hk, using the input device 903c such as the communication device. The parameter receiving unit 309 receives the parameter j, using the input device 903c such as the keyboard or the communication device. The signature receiving unit 310 receives the first signature σ, using the input device 903c such as the communication device. The homomorphic key hk the homomorphic key receiving unit 308 has received, the parameter j the parameter receiving unit 309 has received, and the first signature σ the signature receiving unit 310 has received are written into the storage device 902c. Step S131 is a homomorphic key receiving process, a parameter receiving process, and a signature receiving process.

In step S132, the homomorphic operation unit 311 executes the homomorphic operation algorithm, based on the homomorphic key hk, the parameter j, and the first signature σ written into the storage device 902c. The homomorphic operation unit 311 executes the homomorphic operation algorithm, thereby generating the second signature σ′. The homomorphic operation unit 311 writes, into the storage device 902c, the second signature σ′ generated. Step S132 is a homomorphic operation algorithm execution process.

In step S133, the second signature transmitting unit 312 transmits the second signature σ′ written into the storage device 902c to the signature verification apparatus 104, using the output device 904c such as the communication device. In this case, the second signature transmitting unit 312 transmits the second signature σ′ to the signature verification apparatus 104, as the verification signature vσ to be verified. Alternatively, when character positions in the message m are further interchanged, the second signature transmitting unit 312 transmits the second signature σ′ to the homomorphic operation apparatus 103 including the second signature transmitting unit 312 again. Step S133 is a second signature transmitting process.

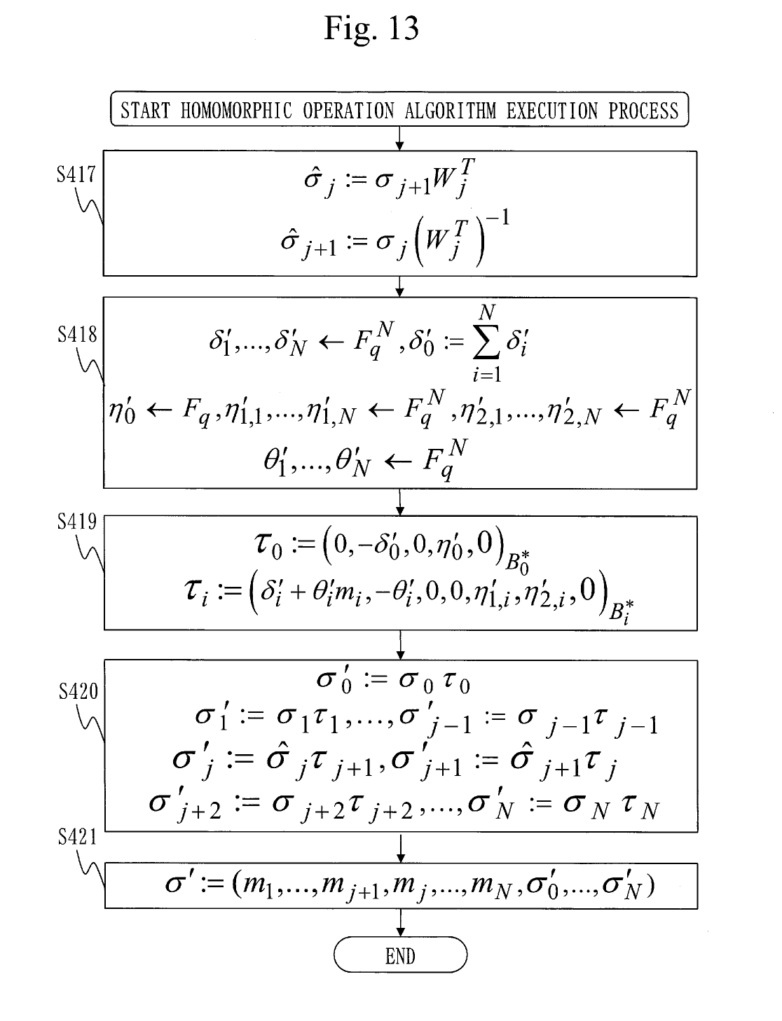

FIG. 13 is a flow diagram of the homomorphic operation algorithm execution process (step S132) that is the execution process of the homomorphic operation algorithm according to this embodiment.

Herein, the homomorphic operation unit 311 inputs, to the homomorphic operation algorithm execution process, the homomorphic key hk the homomorphic key receiving unit 308 has received, the parameter j the parameter receiving unit 309 has received, and the first signature a the signature receiving unit 310 has received. The parameter j is an integer not less than one and not more than N−1. The parameter j indicates that the jth mₘ and the j+1th mₘ₊₁ in the message m (m₁, . . . , m_{N}) become interchanged . That is, the parameter j is an integer indicating the position of the character to be interchanged with the position of the character located to the right by one character.

In step S417, the homomorphic operation unit 311 generates σⱼ̂ and σⱼ₊₁̂, using the elements σⱼ and σⱼ₊₁ of the first signature σ and the Wⱼ included in the homomorphic key hk. The homomorphic operation unit 311 interchanges the jth σⱼ and the j+1th aⱼ₊₁ in the set of the elements a₁, . . . , σ_{N} included in the first signature σ, using, among the transformation matrices W₁, . . . , W_{N-1} included in the homomorphic key hk, the jth transformation matrix Wⱼ where the jth is the value of the parameter j. The homomorphic operation unit 311 generates the σⱼ̂ and the σⱼ₊₁̂ as mentioned above, thereby achieving the character position interchange by interchanging the element of the first signature σ given to the jth character of the message m and the element of the first signature σ given to the j+1th character of the message m. The signature in which the σⱼ and the σⱼ₊₁ of the first signature σ are interchanged is also referred to as an interchanged signature cσ.

In step S418, the homomorphic operation unit 311 generates random numbers δ′₀, . . . , δ′_{N}, a random number η′₀, random numbers η′_{1, 1}, . . . , η′_{1, N}, random numbers η′_{2, 1}, . . . , η′_{2, N}, and random numbers θ′₁, . . . , θ′_{N}.

In step S419, the homomorphic operation unit 311 generates elements τ₀, . . . , τ_{N} from the dual pairing vector spaces, using the subset of the respective bases B₀*, . . . , B_{N}* included in the homomorphic key hk. The homomorphic operation unit 311 generates each of the elements τ₀, . . . , τ_{N} from each character mᵢ contained in the message m, using the subset of the respective bases B₀*, . . . , B_{N}* and the message m (m₁, . . . , m_{N}).

In step S420, the homomorphic operation unit 311 generates elements σ₀′, . . . , σ_{N}′ of the dual pairing vector spaces, using products between the interchanged signature cσ (σ₀, . . . , σⱼ₋₁, σⱼ̂, σⱼ₊₁̂, σⱼ₊₂, . . . , σ_{N}) and the elements ρ (ρ₀, . . . , ρ_{N}) of the dual pairing vector spaces. The homomorphic operation unit 311 generates the elements σ₀′, . . . , σ_{N}′, using the products between the interchanged signature cσ (σ₀, . . . , σⱼ₋₁, σⱼ̂, σⱼ₊₁̂, σⱼ₊₂, . . . , σ_{N}) and the elements τ (τ₀, . . . , τⱼ₋₁, τⱼ₊₁, τⱼ, τⱼ₊₂, . . . , τ_{N}) in which the jth element and the j+1th element are interchanged.

In step S421, the homomorphic operation unit 311 generates the second signature σ′ including the elements σ₀′, . . . , σ_{N}′ generated. Herein, the homomorphic operation unit 311 generates the second signature σ′ including the altered message constituted from the m₁, . . . , mⱼ₋₁, m₊₁, mⱼ, m₊₂, . . . , m_{N}, in which the jth character and the j+1th character are interchanged and the elements σ₀′, . . . , σ_{N}′ generated. That is, the homomorphic operation unit 311 generates the second signature σ′, using the interchanged signature cσ and the elements ρ.

<Operations of Signature Verification Apparatus 104>

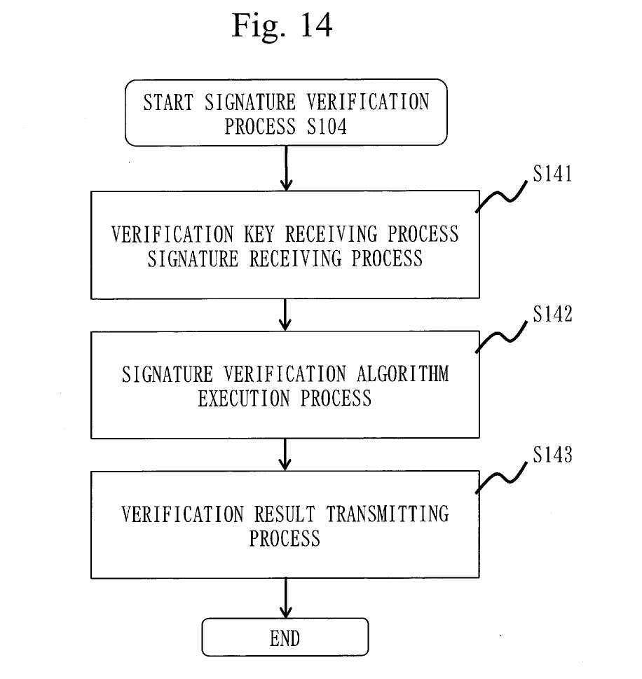

FIG. 14 is a flow diagram illustrating a process flow of the signature verification process S104 according to this embodiment.

In the signature verification process S104, the signature verification apparatus 104 obtains the second signature σ′ as the verification signature vσ, and verifies the verification signature vσ, using the verification key vk. Alternatively, the signature verification apparatus 104 obtains the first signature σ as the verification signature vσ, and verifies the verification signature vσ, using the verification key vk.

In step S141, the verification key receiving unit 313 receives the verification key vk, using the input device 903d such as the communication device. The signature receiving unit 314 receives the verification signature vσ, using the input device 903d such as the communication device. The verification key vk and the verification signature vσ are written into the storage device 902d. The verification signature vσ is the first signature σ or the second signature σ′. The verification can be performed by the signature verification process S104 that is similar regardless of whether the verification signature vσ is the first signature σ or the second signature σ′. Herein, a description will be given, assuming that the verification signature vσ is the first signature σ. Step S141 is a verification key receiving process and a signature receiving process.

In step S142, the signature verification unit 315 executes the signature verification algorithm, based on the verification key vk and the verification signature vσ written into the storage device 902d, and outputs 0 or 1 as the verification result r. The verification result r of 0 or 1 is written into the storage device 902d. Step S142 is a signature verification algorithm execution process.

In step S143, the verification result transmitting unit 316 outputs the verification result r written into the storage device 902d, using the output device 904d such as the communication device or the display device. Step S143 is a verification result transmitting process.

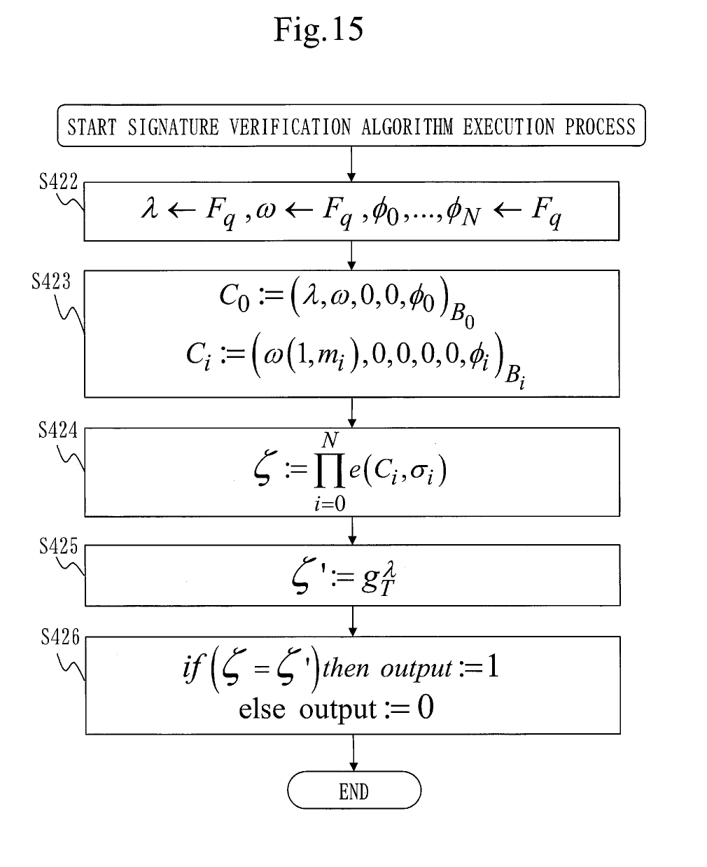

FIG. 15 is a flow diagram of the signature verification algorithm execution process (step S142) that is the execution process of the signature verification algorithm according to this embodiment.

Herein, the signature verification unit 315 inputs, to the signature verification algorithm, the verification key vk the verification key receiving unit 313 has received and the verification signature vσ the signature receiving unit 314 has received.

In step S422, the signature verification unit 315 generates a random number λ, a random number ω, and random numbers φ₀, . . . , φ_{N}.

In step S423, the signature verification unit 315 generates elements c₀, . . . , c_{N} of the dual pairing vector spaces, using the bases B₀, . . . , B_{N} included in the verification key vk. In step S423, i is each of the integers from 1 to N.

In step S424, the signature verification unit 315 generates ζ from the elements σ₀, . . . , σ_{N} of the verification signature va and the elements c₀, . . . , c_{N}. The signature verification unit 315 executes a pairing operation with respect to the elements c₀, . . . , c_{N} and the verification signature vσ, and generates the operation result ζ of the pairing operation.

In step S425, the signature verification unit 351 generates ζ from the random number λ and the generating element g_{T}.

In step S426, the signature verification unit 315 verifies the verification signature vσ, based on the operation result ζ of the pairing operation and the ζ′ generated from the random number λ and the element gᵣ. The signature verification unit 315 compares the ζ with the ζ′, outputs 1 as the verification result r when the ζ and the ζ′ are equal, and outputs 0 as the verification result r otherwise.

The explanation of each of the homomorphic signature process S100 and the homomorphic signature method 500 in the cryptographic system 100 according to this embodiment is finished by the above description.

‡‡‡Description of Effects of This Embodiment‡‡‡

As mentioned above, according to the cryptographic system in this embodiment, interchange of character positions in a character string can be securely implemented by using a mathematical structure different from the mathematical structures used in the conventional schemes.

Further, according to the cryptographic system in this embodiment, a message to be altered and an alterable range can be controlled by the homomorphic key that is dedicated.

‡‡‡Alternative Configuration‡‡‡

In this embodiment, the functions of each apparatus of the cryptographic system 100 are implemented by the software. As a variation example, however, the functions of each apparatus of the cryptographic system 100 may be implemented by hardware.

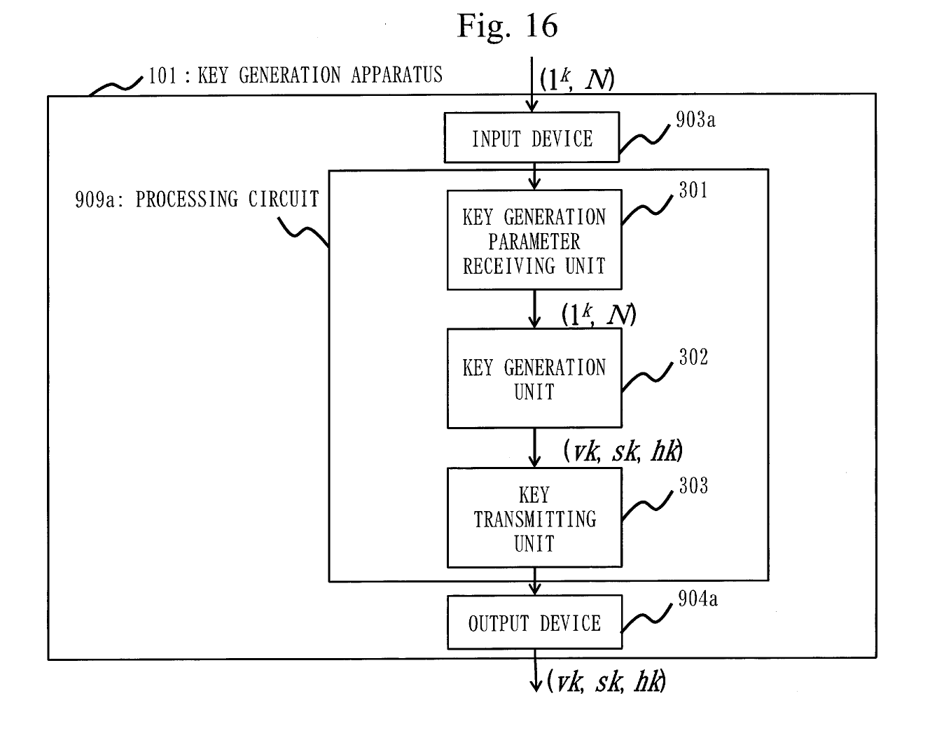

The variation example of this embodiment will be described, using FIGS. 16 to 19.

FIG. 16 is a diagram illustrating a configuration of the key generation apparatus 101 according to the variation example of this embodiment.

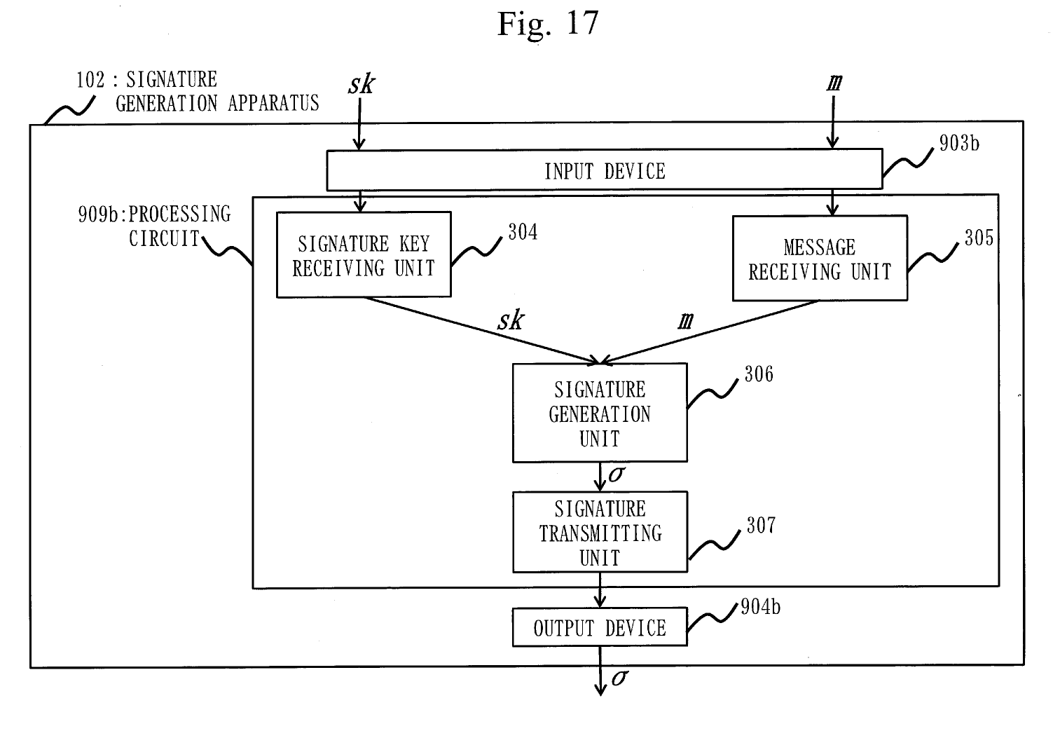

FIG. 17 is a diagram illustrating a configuration of the signature generation apparatus 102 according to the variation example of this embodiment.

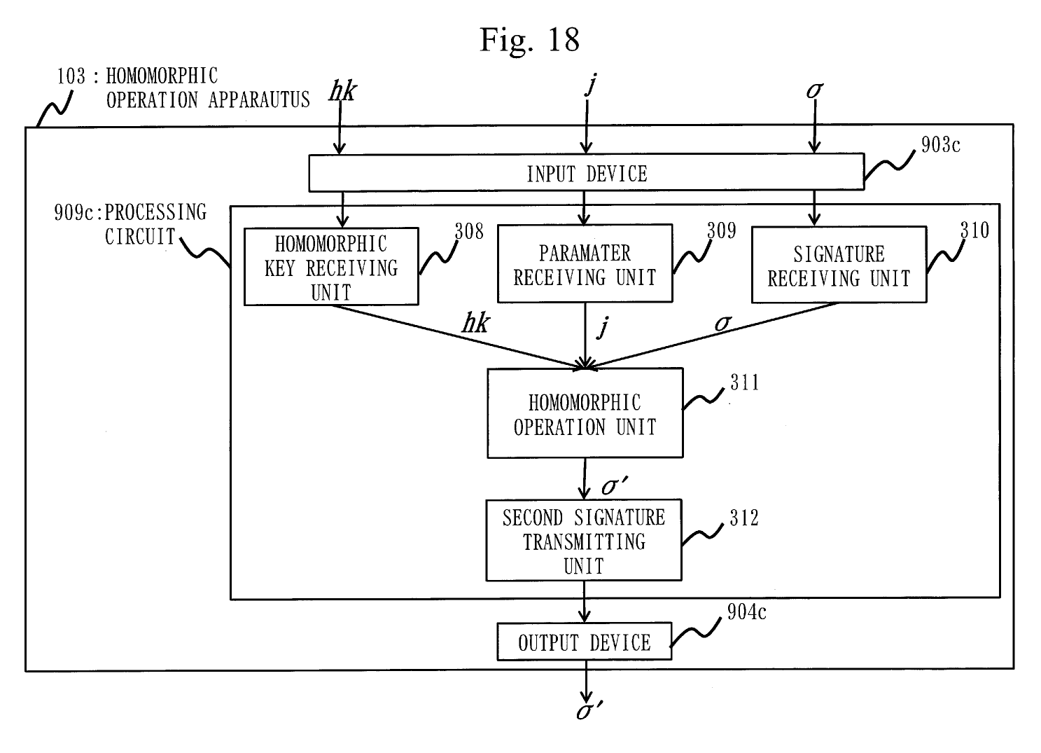

FIG. 18 is a diagram illustrating a configuration of the homomorphic operation apparatus 103 according to the variation example of this embodiment.

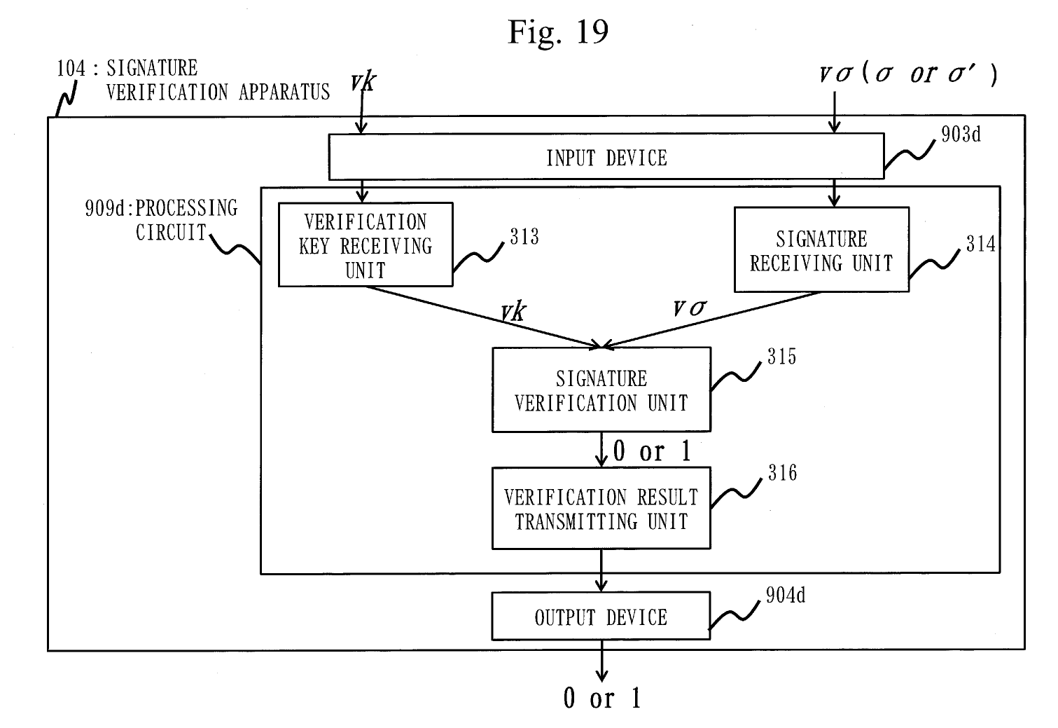

FIG. 19 is a diagram illustrating a configuration of the signature verification apparatus 104 according to the variation example of this embodiment.

As illustrated in FIG. 16, the key generation apparatus 101 includes hardware such as a processing circuit 909a, the input device 903a, and the output device 904a.

As illustrated in FIG. 17, the signature generation apparatus 102 includes hardware such as a processing circuit 909b, the input device 903b, and the output device 904b.

As illustrated in FIG. 18, the homomorphic operation apparatus 103 includes hardware such as a processing circuit 909c, the input device 903c, and the output device 904c.

As illustrated in FIG. 19, the signature verification apparatus 104 includes hardware such as a processing circuit 909d, the input device 903d, and the output device 904d.

In the following description, the processing circuits 909a, 909b, 909c, and 909d will be collectively referred to as a processing circuit 909. The same holds true for the input device 903 and the output device 904.

The processing circuit 909 is an electronic circuit dedicated for implementing the function of each “unit”. Specifically, the processing circuit 909 is a single circuit, a composite circuit, a programmed processor, a parallel-programmed processor, a logic IC, a GA (Gate Array), an ASIC (Application Specific Integrated Circuit), or an FPGA (Field-Programmable Gate Array).

The function of each “unit” may be implemented by one processing circuit 909, or may be implemented by being distributed into a plurality of the processing circuits 909.

As another variation example, the functions of each apparatus of the cryptographic system 100 may be implemented by a combination of the software and the hardware. That is, a part of the functions of each apparatus of the cryptographic system 100 may be implemented by the hardware that is dedicated and a remainder of the functions may be implemented by the software.

The processor 901, the storage device 902, and the processing circuit 909 are collectively referred to as “processing circuitry”. That is, even if the configuration of each apparatus in the cryptographic system 100 is the configuration illustrated in any one of FIGS. 2 to 5 and FIGS. 16 to 19, the function of each “unit” is implemented by the processing circuitry.

Each “unit” may be read as a “step”, a “procedure”, or a “process”. Further, the function of each “unit” may be implemented by firmware.

In this embodiment, the description has been given about a case where he cryptographic system 100 includes the key generation apparatus 101, the signature generation apparatus 102, the homomorphic operation apparatus 103, and the signature verification apparatus 104, and each apparatus is one computer. However, the key generation apparatus 101 and the signature generation apparatus 102 may be one computer, for example. Alternatively, the signature generation apparatus 102 and the homomorphic operation apparatus 103 may be one computer. Alternatively, all the apparatuses may be implemented by one computer.

In this embodiment, the first signature σ and the second signature σ′ each include the message. However, the first signature a and the second signature σ′ may be each added to the message.

The embodiment of the present invention has been described above; however, this embodiment may be implemented in part. Specifically, any one of or an arbitrary combination of some of what are described as the “units” in the description of the embodiment may be adopted. Note that the present invention is not limited to this embodiment, and various modifications may be made as necessary.

### REFERENCE SIGNS LIST

100: cryptographic system; 101: key generation apparatus; 102: signature generation apparatus; 103: homomorphic operation apparatus; 104: signature verification apparatus; 301: key generation parameter receiving unit; 302: key generation unit; 303: key transmitting unit; 304: signature key receiving unit; 305: message receiving unit; 306: signature generation unit; 307: signature transmitting unit; 308: homomorphic key receiving unit; 309: parameter receiving unit; 310: signature receiving unit; 311: homomorphic operation unit; 312: second signature transmitting unit; 313: verification key receiving unit; 314: signature receiving unit; 315: signature verification unit; 316: verification result transmitting unit; 500: homomorphic signature method; 510: homomorphic signature program; 901, 901a, 901b, 901c, 901d: processor; 902, 902a, 902b, 902c, 902d: storage device; 903, 903a, 903b, 903c, 903d: input device; 904, 904a, 904b, 904c, 904d: output device; 909, 909a, 909b, 909c, 909d: processing circuit; S100: homomorphic signature process; S101: key generation process; S102: signature generation process; S103: homomorphic operation process; S104: signature verification process; sk: signature key; hk: homomorphic key; vk: verification key; σ: first signature; σ′: second signature; cσ: interchanged signature; r: verification result; m: message; vσ: verification signature

1-10. (canceled)

11. A cryptographic system comprising:
a key generation apparatus to generate a signature key including a subset of respective bases B₀*, . . . , B_{N}* of dual pairing spaces (N being an integer not less than two), using the bases B₀*, . . . , B_{N}* where the bases after the B₂* are generated by using N−1 transformation matrices W₁, . . . , W_{N-1}; a signature generation apparatus to generate a first signature for a message including N characters, using the signature key, the signature generation apparatus generating a set of elements σ₁, . . . , σ_{N} being elements of the dual pairing vector spaces and including each character contained in the message, using the subset of the respective bases B₀*, . . . , B_{N}* included in the signature key and the message, and generating the first signature including the set of the elements σ₁, . . . , σ_{N} generated; and
a homomorphic operation apparatus to generate a second signature for an altered message where two characters at different positions in the message are interchanged, using the first signature and a homomorphic key different from the signature key, the homomorphic operation apparatus obtaining a parameter and generating the second signature for the altered message where a jth (j being an integer not less than one and not more than N−1) character and a j+1 character in the message are interchanged, using the parameter, the first signature, and the homomorphic key, the jth being a value of the parameter,
wherein the key generation apparatus generates the homomorphic key including the transformation matrices W₁, . . . , W_{N-1} and the subset of the respective bases B₀*, . . . , B_{N}*, and
wherein using, among the transformation matrices W₁, . . . , W_{N-1} included in the homomorphic key, the jth transformation matrix Wⱼ where the jth is the value of the parameter, the homomorphic operation apparatus interchanges the jth σrⱼ and the j+1th σⱼ₋₁ in the set of the elements σ₁, . . . , σ_{N} included in the first signature wherein the jth is the value of the parameter, thereby generating an interchanged signature where the σⱼ and the σⱼ₊₁ are interchanged, and generates the second signature, using the interchanged signature.

12. The cryptographic system according to claim 11,
wherein the homomorphic operation apparatus generates elements ρ₀, . . . , ρ_{N} from the dual pairing vector spaces, using the subset of the respective bases B₀*, . . . , B_{N}* included in the homomorphic key, and generates the second signature, using products between the interchanged signature and the elements ρ₀, . . . , ρ_{N}.

13. The cryptographic system according to claim 11,
wherein the key generation apparatus further generates a verification key including the subset of the respective bases B₀*, . . . , B_{N}* of the dual pairing vector spaces, and
wherein the cryptographic system further comprises a signature verification apparatus to obtain the second signature as a verification signature and verify the verification signature, using the verification key.

14. The cryptographic system according to claim 13,
wherein the signature verification apparatus obtains the first signature as the verification signature, and verifies the verification signature, using the verification key.

15. The cryptographic system according to claim 13,
wherein the signature verification apparatus generates elements c₀, . . . , c_{N} of the dual pairing vector spaces, using the bases B₀, . . . , B_{N} included in the verification key, executes a pairing operation with respect to the elements c₀, . . . , c_{N} and the verification signature, and verifies the verification signature, based on an operation result of the pairing operation.

16. A homomorphic signature method comprising:
generating a signature key including a subset of respective bases B₀*, . . . , B_{N}*of dual pairing spaces (N being an integer not less than two), using the bases B₀*, . . . , B_{N}* where the bases after the B₂* are generated by using N−1 transformation matrices W₁, . . . , W_{N-1};
generating a set of elements σ₁, . . . , σ_{N} being elements of the dual pairing vector spaces and including each character contained in a message including N characters, using the subset of the respective bases B₀*, . . . , B_{N}* included in the signature key and the message, and generating a first signature for the message, the first signature including the set of the elements σ₁, . . . , σ_{N} generated; and
obtaining a parameter and generating a second signature for an altered message where a jth (j being an integer not less than one and not more than N−1) character and a j+1 character in the message are interchanged, using the parameter, the first signature, and a homomorphic key different from the signature key, the jth being a value of the parameter,
wherein the homomorphic key including the transformation matrices W₁, . . . , W_{N-1} and the subset of the respective bases B₀*, . . . , B_{N}* is generated, and
wherein using, among the transformation matrices W₁, . . . , W_{N-1} included in the homomorphic key, the jth transformation matrix Wⱼ where the jth is the value of the parameter, the jth σⱼ and the j+1th σⱼ₋₁ in the set of the elements σ₁, . . . , σ_{N} included in the first signature wherein the jth is the value of the parameter are interchanged, thereby generating an interchanged signature where the σⱼ and the σⱼ₋₁ are interchanged, and the second signature is generated, using the interchanged signature.

17. A non-transitory computer readable medium storing a homomorphic signature program to cause a computer to execute:
a key generation process of generating a signature key including a subset of respective bases B₀*, . . . , B_{N}*of dual pairing spaces (N being an integer not less than two), using the bases B₀*, . . . , B_{N}* where the bases after the B₂* are generated by using N−1 transformation matrices W₁, . . . , W_{N-1};
a signature generation process of generating a set of elements σ₁, . . . , σ_{N} being elements of the dual pairing vector spaces and including each character contained in a message including N characters, using the subset of the respective bases B₀*, . . . , B_{N}* included in the signature key and the message, and generating a first signature for the message, the first signature including the set of the elements σ₁, . . . , σ_{N} generated; and
a homomorphic operation process of obtaining a parameter and generating a second signature for an altered message where a jth (j being an integer not less than one and not more than N−1) character and a j+1 character in the message are interchanged, using the parameter, the first signature, and a homomorphic key different from the signature key, the jth being a value of the parameter,
wherein in the key generation process, the homomorphic key including the transformation matrices W₁, . . . , W_{N-1} and the subset of the respective bases B₀*, . . . , B_{N}* is generated, and
wherein in the homomorphic operation process, using, among the transformation matrices W₁, . . . , W_{N-1} included in the homomorphic key, the jth transformation matrix Wⱼ where the jth is the value of the parameter, the jth σⱼ and the j+1th σⱼ₊₁ in the set of the elements σ₁, . . . , σ_{N} included in the first signature wherein the jth is the value of the parameter are interchanged, thereby generating an interchanged signature where the σⱼ and the σⱼ₊₁ are interchanged, and the second signature is generated, using the interchanged signature.
